(19) United States
(12) Patent Application Publication
(10) Pub. No.: US 2026/0138385 A1
(43) Pub. Date: May 21, 2026

(54) WINDING DEVICE AND RECORDING DEVICE

(71) Applicant: SEIKO EPSON CORPORATION, Tokyo (JP)

(72) Inventors: Ryuichi SATO, SHIOJIRI-SHI (JP); Naohiro UEYAMA, MATSUMOTO-SHI (JP); Yohei NUNOKAWA, SHIOJIRI-SHI (JP); Masahiro HAYASHIBE, SHIOJIRI-SHI (JP)

(21) Appl. No.: 19/385,227

(22) Filed: Nov. 11, 2025

(30) Foreign Application Priority Data
Nov. 15, 2024 (JP) 2024-199453

(51) Int. Cl. B41J 15/04; B41J 2/01

(52) U.S. Cl. CPC B41J 15/046; B41J 2/01

(57) ABSTRACT

A winding device transports a medium formed by attaching fabric to a support member and, while transporting the medium in a transport direction, peels the fabric from the support member and winds up both the fabric and the support member. The winding device includes a first winding shaft configured to wind the support member, a second winding shaft configured to wind the fabric, first nip rollers that nip the medium at an upstream position in the transport direction of the first winding shaft and the second winding shaft, and second nip rollers that nip the fabric at a position downstream of the first nip roller in the transport direction. The peeling position where the fabric is peeled from the support member is between a first nip position where the first nip rollers nip the medium and a second nip position where the second nip rollers nip the fabric.

The present application is based on, and claims priority from JP Application Serial Number 2024-199453, filed November 15, 2024, the disclosure of which is hereby incorporated by reference herein in its entirety.

### BACKGROUND

### 1. Technical Field

The present disclosure relates to a winding device and a recording device.

### 2. Related Art

An example of a prior art device of this kind is described in JP-A-2013-6315.

JP-A-2013-6315 discloses the following. A composite base material includes a printing base material and a support base material bonded together. The composite base material is separated into the printing base material and the support base material by an end roller that is provided on the downstream side of a liquid fixing unit. Winding rolls are disposed so as to separately wind the separated printing base material and support base material. When a medium, such as a fabric, that tends to curl is wound up, since the fabric is wound while being bent when the fabric is peeled off from the support base material, sometimes the fabric curls and rolls up on itself.

### SUMMARY

In order to solve the above-described problem, a winding device according to the present disclosure is a winding device that transports a medium formed by a fabric attached to a support member having an adhesive surface and that, while transporting the medium in a transport direction, peels the fabric from the support member and then separately winds up the fabric and the support member, the winding device including a first winding shaft configured to wind the support member; a second winding shaft configured to wind the fabric peeled off from the support member; a first nip roller configured to nip the medium at an upstream position in the transport direction of the first winding shaft and of the second winding shaft; and a second nip roller configured to nip the fabric at a position downstream of the first nip roller in the transport direction, wherein a peeling position where the fabric is peeled from the support member is a position between a first nip position where the first nip roller nips the medium and a second nip position where the second nip roller nips the fabric.

A recording device according to the present disclosure includes a feed section that feeds a roll-shaped medium in a transport direction, the roll-shaped medium being formed by attaching a fabric to a support member having an adhesive surface, a recording section that performs recording on the medium, and a winding device that is located downstream of the recording section in the transport direction and that separately winds the support member and the fabric, and the winding device is the winding device according to any one of claims 1 to 8.

### BRIEF DESCRIPTION OF THE DRAWINGS

FIG. 1 is a side schematic view of a schematic configuration of a recording device of a first embodiment.

FIG. 2 is a side schematic view of a winding device according to a modification of the first embodiment.

FIG. 3 is a side schematic view of a winding device according to a second embodiment.

FIG. 4 is a side schematic view of a winding device according to a third embodiment.

FIG. 5 is a side schematic view of a winding device according to a fourth embodiment.

FIG. 6 is a side schematic view of a winding device according to the fourth embodiment.

FIG. 7 is a side schematic view of a winding device according to the fourth embodiment.

### DESCRIPTION OF EMBODIMENTS

Hereinafter, the present disclosure will be schematically described.

In order to solve the above-described problem, a winding device according to a first aspect of the present disclosure is a winding device that transports a medium formed by a fabric attached to a support member having an adhesive surface and that, while transporting the medium in a transport direction, peels the fabric from the support member and then separately winds up the fabric and the support member, the winding device including a first winding shaft configured to wind the support member; a second winding shaft configured to wind the fabric peeled off from the support member; a first nip roller configured to nip the medium at an upstream position in the transport direction of the first winding shaft and of the second winding shaft; and a second nip roller configured to nip the fabric at a position downstream of the first nip roller in the transport direction, wherein a peeling position where the fabric is peeled from the support member is a position between a first nip position where the first nip roller nips the medium and a second nip position where the second nip roller nips the fabric.

According to the present aspect, the peeling position where the fabric is peeled from the support member is a position between a first nip position where the first nip roller nips the medium and a second nip position where the second nip roller nips the fabric. The fabric between the first nip position and the second nip position is transported while being held in a flat posture in a state of the fabric being nipped at two positions, at an upstream side and at a downstream side in a transport direction, by the first nip rollers and the second nip rollers. By this, the fabric is peeled off from the support member at the portion where the fabric is held in the flat posture, that is, the fabric is peeled off in a state where bending of the fabric such as in the related art is suppressed, and thus it is possible to suppress curling tendency of the fabric.

The winding device according to a second aspect of the present disclosure is an aspect according to the first aspect, wherein assuming that a direction of the support member from the peeling position toward the first winding shaft is a first direction and a transport direction of the medium toward the peeling position is a second direction, the first winding shaft is disposed at a position where an angle formed by the first direction and the second direction is an acute angle.

According to the present aspect, the first winding shaft is disposed at a position where an angle formed by a first direction, which is a direction of the support member from the peeling position toward the first winding shaft, and a second direction, which is a transport direction of the medium toward the peeling position, is an acute angle. By this, the force of the first winding shaft winding the support member can be efficiently converted into the force of peeling the support member from the fabric.

The winding device according to a third aspect of the present disclosure is an aspect according to the first aspect, wherein the first winding shaft is disposed at a position where a component of a winding force by which the support member after the fabric is peeled off is wound around the first winding shaft includes a component in a direction opposite to the transport direction of the medium toward the peeling position.

According to the present aspect, the first winding shaft is disposed at a position where a component of a winding force with which the support member after the fabric is peeled off is wound around the first winding shaft includes a component in a direction opposite to the transport direction. By this, since the component in the direction opposite to the transport direction acts as a force for peeling the support member from the fabric, the winding force by the first winding shaft can be efficiently converted into the peeling force.

The winding device according to a fourth aspect of the present disclosure is an aspect according to the first aspect, and further includes a detection section that detects a winding amount of the support member wound around the first winding shaft and a control section that controls the winding speed of the support member by the first winding shaft based on the winding amount.

It should be noted that this aspect may be according to the second aspect or the third aspect.

The support medium is wound around the first winding shaft to form a roll body, and the diameter of the roll body gradually increases. When the winding speed of the first winding shaft, that is, the movement speed of the support member toward the roll body is controlled to be constant, the peeling position at which the fabric is peeled from the support member is displaced as the diameter of the roll body increases. That is, the peeling position moves toward the second nip roller, and may not be held between the first nip position and the second nip position.

According to the present aspect, the detection section detects the winding amount of the support member wound around the first winding shaft, and the control section controls the winding speed based on the winding amount. By this, by performing the control of increasing the winding speed, the peeling position at which the fabric is peeled from the support member can be maintained between the first nip position and the second nip position.

A winding device according to a fifth aspect of the present disclosure is an aspect according to the fourth aspect, wherein the detection section includes a driven roller that contacts the support member after the fabric is peeled off and the control section obtains the winding amount based on rotation of the driven roller.

According to the present aspect, the detection section includes a driven roller that contacts the support member after the fabric is peeled off. The control section is configured to obtain the winding amount based on the rotation of the driven roller. By this, the winding speed can be controlled by a simple configuration of the driven roller.

A winding device according to a sixth aspect of the present disclosure is an aspect according to the first aspect, further includes a first detection section and a second detection section that are disposed separated from each other at positions sandwiching the support member after the fabric is peeled off and that are configured to detect distance from the support member and a control section that controls a winding speed of the support member by the first winding shaft based on the distance.

It should be noted that this aspect may be according to the second aspect or the third aspect.

According to the present aspect, the winding device includes the first detection section and the second detection section, which are disposed to be separated from each other at positions sandwiching the support member after the fabric is peeled off, and are capable of detecting distance from the support member. The control section is configured to control a winding speed of the support member by the first winding shaft based on the distance. By this, it is possible to keep the position at which the support member is peeled off from the fabric between the first nip position and the second nip position.

Winding device according to a seventh aspect of the present disclosure is an aspect according to the first aspect, further includes a drying section configured to dry the medium, wherein the first nip roller and the second nip roller are disposed both at a position downstream of the drying section in the transport direction and at a position upstream of the drying section in the transport direction and the first winding shaft is also disposed at both sides corresponding to the first nip roller and the second nip roller that are located downstream and corresponding to a first nip roller and a second nip roller that are located upstream.

It should be noted that the present aspect may be according to any one of the second aspect to the sixth aspect.

The adhesive forming the adhesive surface includes a type of adhesive whose adhesive force is weakened by heat. In this type of case, peeling is easier when performed after the drying treatment by the drying section.

On the other hand, some of the adhesives are of a type of whose adhesive force is increased by heat. The support member may be of a type that is easily wrinkled by heat, such as a paper base material. There is a case where it is desired to shorten the drying time by drying treatment alone after peeling off the fabric from the support member.

According to the present aspect, the first nip roller and the second nip roller are respectively disposed at both a position downstream of the drying section and a position upstream of the drying section in the transport direction. First winding shafts are also disposed on both sides corresponding to the first nip roller and the second nip roller at the downstream position and corresponding to the first nip roller and the second nip roller at the upstream position. This allows the user to select and execute a case where peeling is preferably performed after the drying treatment or a case where peeling is preferably performed before the drying treatment.

A winding device according to an eighth aspect of the present disclosure is an aspect according to the first aspect, wherein the first nip roller and the second nip roller are configured to be movable between a position downstream of the drying section in the transport direction and a position upstream of the drying section in the transport direction and the first winding shaft is also configured to be movable between a position downstream of the drying section in the transport direction and a position upstream of the drying section in the transport direction.

It should be noted that the present aspect may be according to any one of the second aspect to the sixth aspect.

According to the present aspect, the set of the first nip roller, the second nip roller, and the first winding shaft is configured to be movable between the position upstream of the drying section and the position downstream of the drying section. By this, as in the seventh aspect, the user can appropriately select and execute the case where peeling is preferably performed after the drying treatment and the case where peeling is preferably performed before the drying treatment.

A recording device, the recording device includes according to a ninth aspect of the present disclosure a feed section that feeds a roll-shaped medium in a transport direction, the roll-shaped medium being formed by attaching a fabric to a support member having an adhesive surface; a recording section that performs recording on the medium; and a winding device that is located downstream of the recording section in the transport direction and that separately winds the support member and the fabric, wherein

The winding device is according to any one of the first to eighth aspects.

According to this aspect, it is possible to obtain the effect obtained in any one of the first to eighth aspects as the recording device.

### EMBODIMENTS

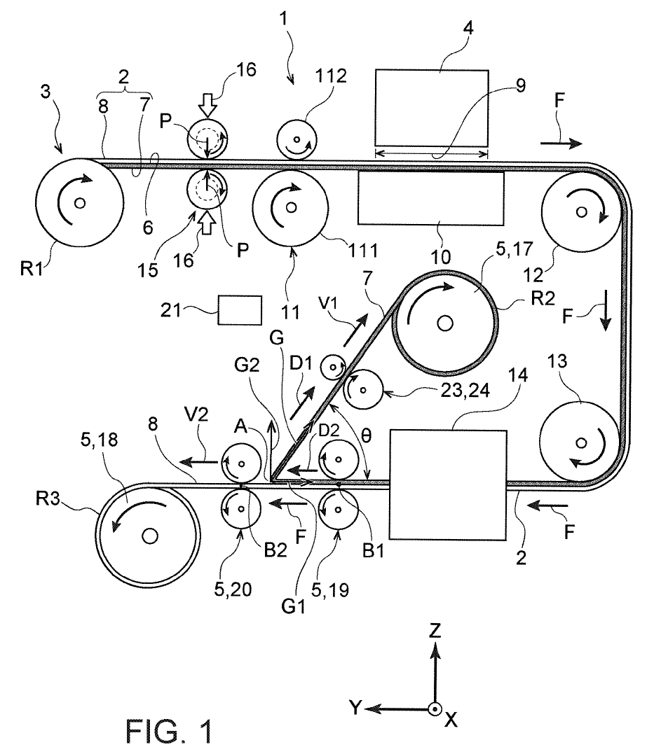

Hereinafter, a winding device and a recording device according to an embodiment of the present disclosure will be described in detail with reference to FIGS. 1 to 7.

In the following description, as illustrated in each drawing, three axes orthogonal to each other are referred to as an X-axis, a Y-axis, and a Z-axis, respectively. The direction indicated by the arrows of the three axes (X, Y, and Z) is the + direction of each direction, and the opposite direction is the - direction. The Z-axis direction corresponds to a vertical direction, that is, a direction in which gravity acts, a +Z direction indicates a vertically upward direction and a -Z direction indicates a vertically downward direction. The X-axis direction and the Y-axis direction correspond to horizontal directions. The +Y direction indicates the forward direction of the recording device and the -Y direction indicates the rearward direction of the recording device. The +X direction indicates the right direction of the recording device and the -X direction indicates the left direction of the recording device.

### FIRST EMBODIMENT

The recording device 1 of the present embodiment is an inkjet printer as an example.

As illustrated in FIG. 1, the recording device 1 includes a feed section 3 that feeds a medium 2 in a transport direction F, a recording section 4, and a winding device 5.

The medium 2 is a roll-shaped medium in which a sheet-like fabric 8 is attached to a sheet-like support member 7 having an adhesive surface 6. The medium 2 is set in the feed section 3 in a state of the roll body R1. The feed section 3 rotates the roll body R1 to feed the medium 2 in the transport direction F. The recording section 4 performs recording by ejecting ink onto the fabric 8 of the fed medium 2 in the recording execution region 9. In the recording execution region 9, the medium 2 is supported by a platen 10. The winding device 5 will be described later.

As illustrated in FIG. 1, the recording device 1 includes a transport section 11 that applies a transporting force to the medium 2 toward the recording section 4, intermediate rollers 12, 13 and a drying section 14.

The transport section 11 is configured by a pair of rollers including a transport roller 111 that rotates by receiving power from a drive source and a pressing roller 112 that rotates by following the rotation of the transport roller 111. The intermediate rollers 12, 13 are disposed at positions where the transport direction F of the medium 2 is to be changed, and are driven to rotate in accordance with movement of the medium 2 in the transport direction F. The drying section 14 heats and dries the fabric 8 of the medium 2 onto which the ink was ejected.

As illustrated in FIG. 1, the recording device 1 includes a pressing section 15. The pressing section 15 is located upstream of the recording section 4 and the transport section 11 in the transport direction F. The pressing section 15 is configured to sandwich the medium 2 moving in the transport direction F and to press the medium 2 by applying a pressing force P. The pressing section 15 is configured such that the pressing force P to the medium 2 can be adjusted by the adjustment section 16 in accordance with the type of the medium 2. The adjustment section 16 may have any structure as long as the adjustment section 16 can perform adjustment to increase or decrease the pressing force P, and an example of the structure is a structure using a spring and a cam, but the structure is not limited to a specific structure.

In the present embodiment, the magnitude of the appropriate pressing force P is grasped and determined in advance by trial production or the like for a plurality of types of the medium 2 assumed to be used. When a user performs an operation of specifying the type of the medium 2 through an operation panel or the like (not illustrated), the corresponding pressing force P acts on the medium 2 through the adjustment section 16.

### Winding device

Next, the structure of the winding device 5 according to the first embodiment will be described with reference to FIG. 1.

The winding device 5 peels off the fabric 8 from the support member 7 and winds the fabric 8 while transporting the medium 2, in which the fabric 8 is attached to the support member 7 having the adhesive surface 6, in the transport direction F. The winding device 5 includes a first winding shaft 17 that winds the support member 7 and a second winding shaft 18 that winds the fabric 8 that was peeled off from the support member 7.

The winding device 5 includes first nip rollers 19 and second nip rollers 20. The first nip rollers 19 are disposed upstream of the first winding shaft 17 and the second winding shaft 18 in the transport direction F. The first nip rollers 19 nip, that is, hold the medium 2 at a first nip position B1. The second nip rollers 20 are disposed downstream of the first nip rollers 19 in the transport direction F. The second nip rollers 20 nips, that is, hold, the fabric 8 at a second nip position B2.

In the present embodiment, the first winding shaft 17 and the second winding shaft 18, and the first nip rollers 19 and the second nip rollers 20 are disposed on the downstream side of the drying section 14 in the transport direction F. The fabric 8 is transported while being held in a flat posture in a state of the fabric 8 being nipped at two positions, at an upstream side and at a downstream side in the transport direction F, by the first nip rollers 19 and by the second nip rollers 20.

The winding device 5 is configured such that a peeling position A at which the fabric 8 is peeled from the support member 7 is a position between the first nip position B1 and the second nip position B2. That is, the winding speed V1 of the first winding shaft 17 and the winding speed V2 of the second winding shaft 18 are controlled by the control section 21 to be the same speed, and the peeling position A is configured to be a position between the first nip position B1 and the second nip position B2.

The position between the first nip position B1 and the second nip position B2 is literally "a position therebetween," and does not include the first nip position B1 and the second nip position B2.

An appropriate interval between the first nip position B1 and the second nip position B2 varies depending on the type of the medium 2, but if the interval is too large, the flatness of the fabric 8 at the peeling position A is likely to decrease, and thus, the interval is preferably set in a range from the 30mm to the 150mm.

In the present embodiment, assuming that the direction of the support member 7 from the peeling position A toward the first winding shaft 17 is a first direction D1 and the transport direction F of the medium 2 toward the peeling position A is a second direction D2, then the first winding shaft 17 is disposed at a position where an angle θ formed by the first direction D1 and the second direction D2 is an acute angle.

The angle θ being an acute angle can be defined as follows.

The first winding shaft 17 is disposed at a position where components of a winding force G by which the support member 7 is wound around the first winding shaft 17 after the fabric 8 is peeled off include a component G1 in the direction opposite to the transport direction F of the medium 2 as it moves toward the peeling position A. The reference symbol G2 illustrates the other component.

In other words, the first winding shaft 17 is disposed at a position where the support member 7 is peeled off at an acute angle from the fabric 8 between the first nip position B1 and the second nip position B2. In still other words, the first winding shaft 17 is disposed at a position where an angle formed by the surface of the support member 7 before the fabric 8 is peeled off and the surface of the support member 7 after the fabric 8 is peeled off is an acute angle.

In the present embodiment, the winding device includes a detection section 23 that detects a winding amount M of the support member 7 wound around the first winding shaft 17. The control section 21 is configured to control the winding speed V1 of the support member 7 by the first winding shaft 17 based on the winding amount M.

Here, the detection section 23 includes a driven roller 24 that comes into contact with the support member 7 after the fabric 8 is peeled off and is driven to rotate by the movement of the support member 7. The control section 21 is configured to calculate and obtain the winding amount M based on the rotation of the driven roller 24.

The support member 7 is wound around the first winding shaft 17 to form a roll body R2, and the diameter of the roll body R2 gradually increases. When the winding speed V1 of the first winding shaft 17, that is, the movement speed of the support member 7 toward the roll body R2 is controlled to be constant, the peeling position A at which the support member 7 is peeled from the fabric 8 is gradually displaced as the diameter of the roll body R2 increases. That is, the peeling position A gradually moves toward the second nip rollers 20 side, which is the downstream side in the transport direction F, and may not be maintained between the first nip position B1 and the second nip position B2.

An increase in the winding amount M means an increase in the diameter of the roll body R2. Therefore, if the winding amount M is known, the displacement state of the peeling position A is known.

In the present embodiment, the control section 21 performs control to adjust the winding speed V1 so that the peeling position A can be held between the first nip position B1 and the second nip position B2 from the obtained winding amount M. In concrete terms, when the winding amount M reaches a set value, the winding speed V1 is controlled to be increased.

The relationship between the winding amount M and the winding speed V1 for maintaining the peeling position A between the first nip position B1 and the second nip position B2 is obtained in advance by performing a test run or the like. Concretely, when the winding amount M reaches a set value, the winding speed is increased from V1 to V1 +α based on the relationship between the winding amount M and the winding speed V1 obtained in advance. Here, α indicates an increase in the winding speed, and is set in advance so that the peeling position A moves in a direction away from the second nip rollers 20.

In the present embodiment, the adjustment of the winding speed V1 is configured to be performed by changing the rotation speed of the first winding shaft 17. In the present embodiment, the rotation speed of the first winding shaft 17 can be directly adjusted by a user using a speed adjustment section (not illustrated).

That is, it is a configuration such that when the user confirms the displacement state of the peeling position A and confirms that the peeling position A is gradually moving toward the second nip rollers 20, the winding speed V1 can be additionally adjusted by the speed adjustment section so that the peeling position A can be maintained between the first nip position B1 and the second nip position B2, in addition to the adjustment of the winding speed V1 based on the winding amount M.

The present embodiment is configured to, when the winding speed V1 of the first winding shaft 17 is changed, the winding speed V2 of the second winding shaft 18 is also changed in conjunction with the change of the winding speed V1 of the first winding shaft 17, to be the same speed as the first winding speed V1. The fabric 8 is wound around the second winding shaft 18 to form a roll body R3.

The operations of the feed section 3, the pressing section 15, the transport section 11, the recording section 4, the drying section 14, the first winding shaft 17, the second winding shaft 18, and the detection section 23 are performed by the control section 21. The control section 21 includes a CPU, a flash ROM, and a RAM. The CPU performs various arithmetic processes according to the program stored in the flash ROM and controls the operation of the recording device 1 as a whole. The flash ROM, which is an example of the storage unit, is a non-volatile memory that can be read from or written into. Various kinds of information are temporarily stored in the RAM, which is an example of the storage unit.

### From setting of roll body in recording device to start of winding

First, the roll body R1 is set in the feed section 3. The leading end of the medium 2 is pulled out from the roll body R1 and passes through the transport path formed by the pressing section 15, the transport section 11, the recording section 4, the intermediate rollers 12, 13, the drying section 14, and the first nip rollers 19.

The support member 7 and the fabric 8 of the medium 2 are peeled off before the second nip rollers 20. The support member 7 is set to be wound around the first winding shaft 17 through the detection region of the detection section 23. The fabric 8 is set by being passed through the second nip rollers 20 and being wound around the second winding shaft 18. By this, the peeling position A is located between the first nip position B1 and the second nip position B2.

In this state, when the recording is started, the medium 2 is transported in the transport direction F by the control of the control section 21, the ink is ejected by the recording section 4 to execute recording, drying treatment is performed by the drying section 14, and the medium is wound by the winding device 5.

### Winding by winding device

The winding device 5 rotates the first winding shaft 17 to wind the support member 7, and rotates the second winding shaft 18 to wind the fabric 8. The support member 7 and the fabric 8 are wound in a state where the peeling position A is located between the first nip position B1 and the second nip position B2. The winding speed V1 of the first winding shaft 17 and the winding speed V2 of the second winding shaft 18 are set to be the same.

The fabric 8 between the first nip position B1 and the second nip position B2 is transported while being held in a flat posture in a state of the fabric 8 being held at two positions, at the upstream side and at the downstream side in the transport direction F, by the first nip rollers 19 and the second nip rollers 20. That is, the support member 7 is peeled off from the fabric 8 at a portion where the fabric 8 is held in a flat posture.

### Modified example of first embodiment

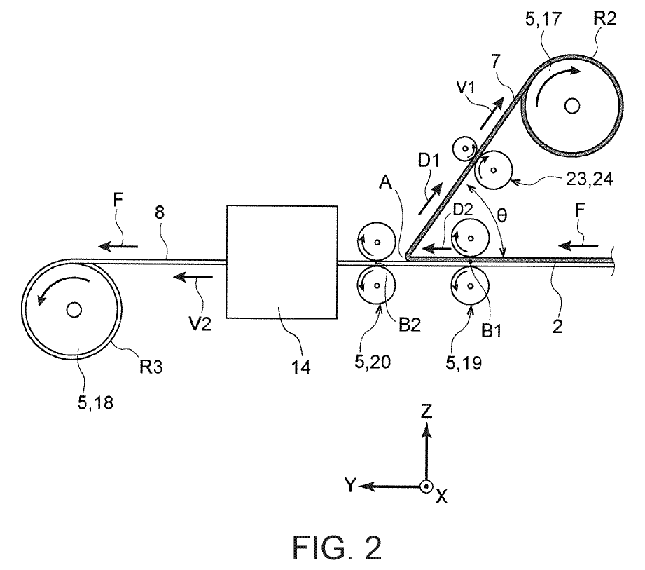

FIG. 2 illustrates a modification of the first embodiment.

In the above description of the first embodiment based on FIG. 1, the first winding shaft 17 and the second winding shaft 18, and the first nip rollers 19 and the second nip rollers 20 are disposed on the downstream side of the drying section 14 in the transport direction F.

In contrast, in the present modification, as illustrated in FIG. 2, the first winding shaft 17 and the second winding shaft 18, and the first nip rollers 19 and the second nip rollers 20 are disposed on the upstream side of the drying section 14 in the transport direction F. The drying section 14 is disposed between the second nip rollers 20 and the second winding shaft 18. The only difference is this point, and the other structures are the same.

### Description of effects of first embodiment

(1) In the present embodiment, the peeling position A where the fabric 8 is peeled from the support member 7 is a position between the first nip position B1 where the first nip rollers 19 nip the medium 2 and the second nip position B1 where the second nip rollers 20 nip the fabric 8. The fabric 8 between the first nip position B1 and the second nip position B2 is transported while being held in a flat posture in a state of the fabric 8 being held at two positions, at the upstream side and at the downstream side in the transport direction F, by the first nip rollers 19 and the second nip rollers 20. By this, the fabric 8 is peeled off from the support member 7 at the portion where the fabric 8 is held in the flat posture, that is, the fabric 8 is peeled off in a state where bending of the fabric 8 such as in the related art is suppressed, and thus it is possible to suppress any curling tendency of the fabric 8.

(2) In the present embodiment, the first winding shaft 17 is disposed at a position where the angle θ formed by the first direction D1, which is the direction of the support member 7 from the peeling position A toward the first winding shaft 17, and the second direction D2, which is the transport direction F of the medium 2 toward the peeling position A, is an acute angle. By this, the winding force G with which the first winding shaft 17 winds the support member 7 can be efficiently converted into a force for peeling the support member 7 from the fabric 8.

(3) In the present embodiment, the first winding shaft 17 is disposed at a position where the components of the winding force G by which the support member 7 from which the fabric 8 was peeled off is wound around the first winding shaft 17 include the components G1 in the direction opposite to the transport direction F. By this, the components G1 in the direction opposite to the transport direction F act as a force for peeling the support member 7 from the fabric 8, and thus the winding force G by the first winding shaft 17 can be efficiently converted into a peeling force.

(4) The support member 7 is wound around the first winding shaft 17 to form the roll body R1, and the roll body R1 gradually increases in diameter. When the winding speed V1 of the first winding shaft 17, that is, the movement speed of the support member 7 toward the roll body R1 is controlled to be constant, the peeling position A at which the fabric 8 is peeled from the support member 7 is displaced as the diameter of the roll body R1 increases. That is, the peeling position A moves toward the second nip rollers 20, and may not be held between the first nip position B1 and the second nip position B2.

In the present embodiment, the detection section 23 detects the winding amount M of the support member 7 wound around the first winding shaft 17, and the control section 21 controls the winding speed V1 based on the winding amount M. By this, by performing the control of increasing the winding speed V1, the peeling position A where the fabric 8 is peeled from the support member 7 can be maintained between the first nip position B1 and the second nip position B2.

(5) In the present embodiment, the detection section 23 includes the driven roller 24 that comes into contact with the support member 7 after the fabric 8 was peeled off. The control section 21 is configured to obtain the winding amount M based on the rotation of the driven roller 24. By this, the winding speed V1 can be controlled by a simple configuration of the driven roller 24.

### SECOND EMBODIMENT

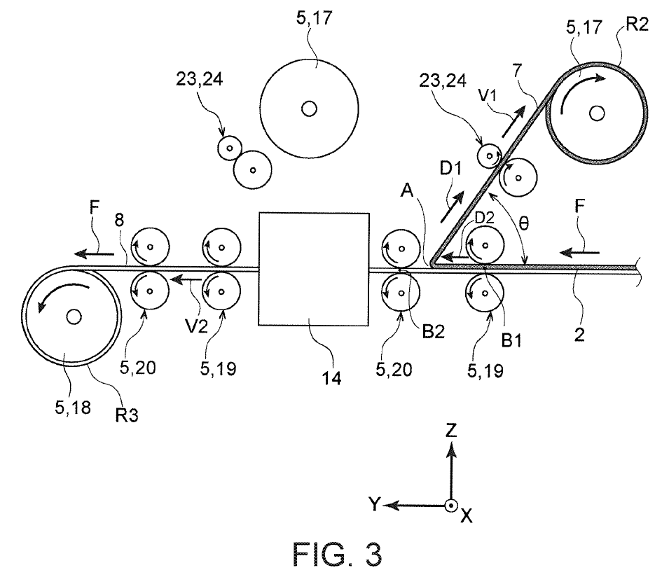

Next, a winding device 5 according to a second embodiment will be described with reference to FIG. 3. The same parts as those in the first embodiment are denoted by the same reference symbols, and the description of their configuration and corresponding effects will be omitted. In the present embodiment, the first nip rollers 19 and the second nip rollers 20 are disposed at both a position downstream of the drying section 14 and a position upstream of the drying section 14 in the transport direction F. First winding shafts 17 are also disposed at both sides corresponding to the first nip rollers 19 and the second nip rollers 20 that are located downstream of the drying section 14 and corresponding to the first nip rollers 19 and the second nip rollers 20 that are located upstream of the drying section 14. In the present embodiment, as illustrated in FIG. 3, detection sections 23 are also disposed on both sides.

FIG. 3 illustrates a state in which a set is used including the first nip rollers 19, the second nip rollers 20, the first winding shaft 17, and the detection section 23 that are disposed at positions upstream of the drying section 14.

Some adhesives that form the adhesive surface 6 are of a type whose adhesive force is weakened by heat. In this type of case, the peeling is easier when the peeling is performed after the drying treatment by the drying section 14.

On the other hand, some of the adhesives are of a type of whose adhesive force is increased by heat. The support member 7 may be of a type that is easily wrinkled by heat, such as a paper base material. Sometimes it is desirable to shorten the drying time by performing a drying treatment on only the fabric 8 after the fabric 8 has been peeled off from the support member 7.

In the present embodiment, as described above, the first nip rollers 19 and the second nip rollers 20 are disposed at both the downstream position and the upstream position of the drying section 14 in the transport direction F. First winding shafts 17 are also disposed at both sides corresponding to the first nip rollers 19 and the second nip rollers 20 that are located downstream and corresponding to the first nip rollers 19 and the second nip rollers 20 that are located upstream.

By this, the user can appropriately select and execute a case where the fabric 8 is preferably peeled off after the drying treatment by the drying section 14 and a case where the fabric 8 is preferably peeled off before the drying treatment as the position at which the fabric 8 is peeled off from the support member 7.

### THIRD EMBODIMENT

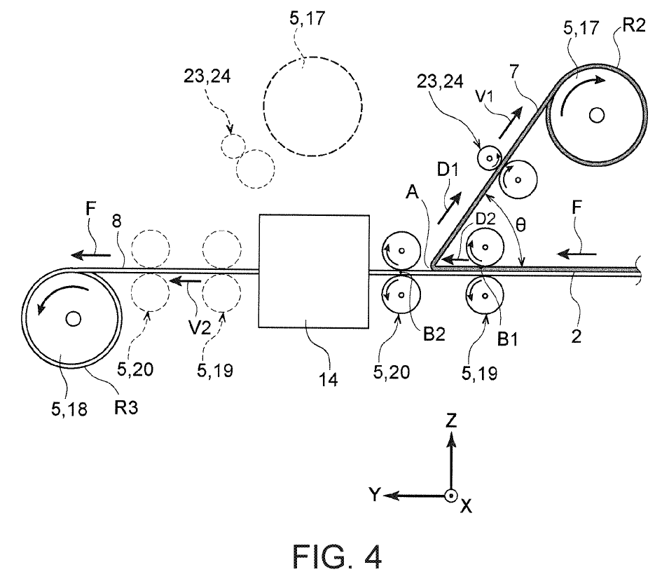

Next, a winding device 5 according to a third embodiment will be described with reference to FIG. 4. The same parts as those in the first embodiment are denoted by the same reference symbols, and the description of their configuration and corresponding effects will be omitted. In the present embodiment, the first nip rollers 19 and the second nip rollers 20 are configured to be movable between a position downstream of the drying section 14 and a position upstream of the drying section 14 in the transport direction F. Here, the drying section 14 is configured to be separable into an upper portion and a lower portion. The upper portion and the lower portion of the drying section 14 are separated from each other, so that the first nip rollers 19 and the second nip rollers 20 can move between the upstream position and the downstream position.

The first winding shaft 17 is also configured to be movable between a position downstream of the drying section 14 and a position upstream of the drying section 14 in the transport direction F. The first winding shaft 17 is disposed on a moving rail (not illustrated) and is configured to be movable between the upstream position and the downstream position. In the present embodiment, the detection section 23 is also configured to be movable between a position downstream of the drying section 14 and a position upstream of the drying section 14 in the transport direction F. The detection section 23 is also disposed on a moving rail (not illustrated) and is configured to be movable between the upstream position and the downstream position.

In the present embodiment, the set of the first nip rollers 19, the second nip rollers 20, and the first winding shaft 17 is configured to be movable between a position upstream of the drying section 14 and a position downstream of the drying section 14. By this, as in the third embodiment, the user can appropriately select and execute a case where peeling is preferably performed after the drying treatment by the drying section 14 and a case where the peeling is preferably performed before the drying treatment.

FIG. 4 illustrates a case where the set of the first nip rollers 19, the second nip rollers 20, the first winding shaft 17, and the detection section 23 is disposed at a position upstream of the drying section 14.

### FOURTH EMBODIMENT

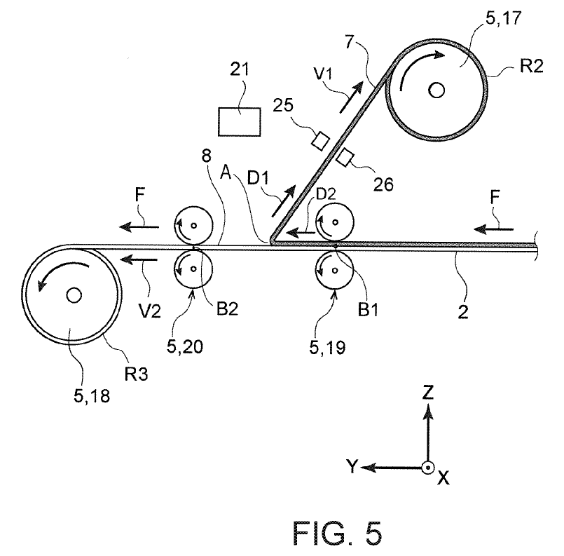

Next, a winding device 5 according to a fourth embodiment will be described with reference to FIGS. 5 to 7. The same parts as those in the first embodiment are denoted by the same reference symbols, and the description of their configuration and corresponding effects will be omitted.

In the present embodiment, a first detection section 25 and a second detection section 26 are disposed at positions sandwiching the support member 7 after the fabric 8 was peeled off, are separated from each other, and are capable of detecting the distance to the support member 7. The control section 21 controls the winding speed V1 of the support member 7 by the first winding shaft 17 based on the distances. In the present embodiment, the control section 21 is configured to control the winding speed V1 of the first winding shaft 17 based on the support member 7 having come into contact with the first detection section 25 so that the distance has become zero, and based on the support member 7 having come into contact with the second detection section 26 so that the distance has become zero. It should be noted that the winding speed V1 of the first winding shaft 17 may be controlled based on the first detection section 25 having detected that the distance between the first detection section 25 and the support member 7 was equal to or less than a predetermined value, and based on the second detection section 26 having detected that the distance between the second detection section 26 and the support member 7 was equal to or less than the predetermined value.

### Winding by winding device

When the first winding shaft 17 continues to wind the support member 7 at the winding speed V1 in the state illustrated in FIG. 5, the diameter of the roll body R2 gradually increases. Then, the peeling position A gradually moves toward the second nip rollers 20. This movement gradually reduces the distance between the first detection section 25 and the support member 7.

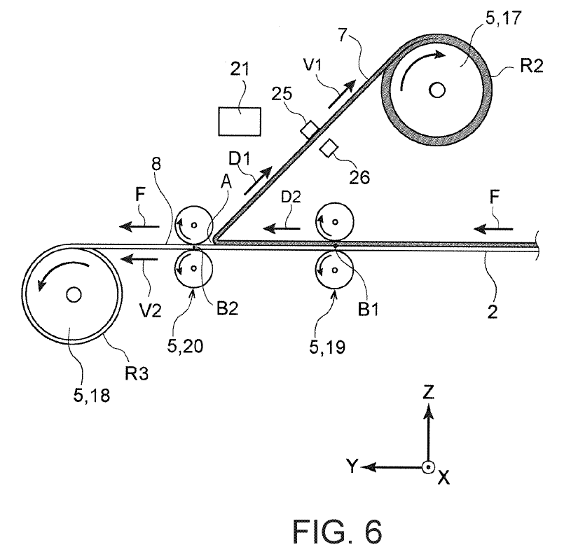

As illustrated in FIG. 6, when the support member 7 comes into contact with the first detection section 25 and the distances become zero, the control section 21 increases the winding speed from V1 to V1 +α. Here, α indicates an increase in the winding speed as described above, and is set in advance so that the peeling position A moves in a direction away from the second nip rollers 20.

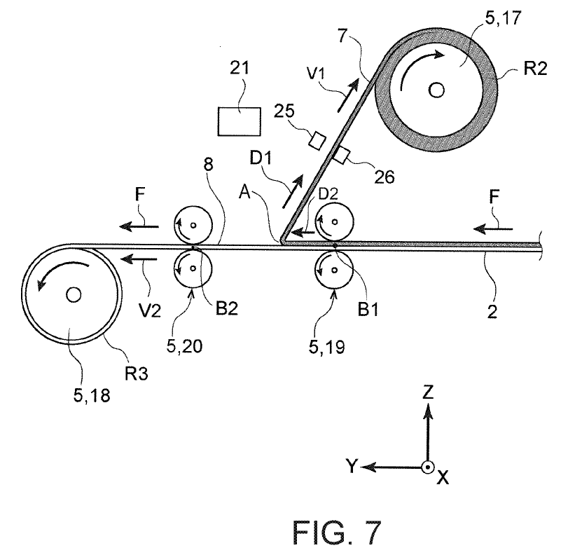

When the first winding shaft 17 continues to wind the support member 7 at the winding speed V1 +α, the peeling position A gradually moves in a direction approaching the first nip rollers 19. As illustrated in FIG. 7, when the support member 7 comes into contact with the second detection section 26 so that the distance becomes zero, the control section 21 is configured to return the winding speed from V1 +α to V1. By this, the peeling position A gradually moves away from the second detection section 26. Thereafter, the states of FIGS. 5, 6, and 7 are repeated.

In the present embodiment, the first detection section 25 and the second detection section 26 are provided which are disposed to be separated from each other at positions sandwiching the support member 7 after the fabric 8 was peeled off, and which can detect the distance to the support member 7. The control section 21 is configured to control the winding speed V1 of the support member 7 by the first winding shaft 17 based on the distances. By this, it is possible to keep the position A where the support member 7 is peeled off from the fabric 8 at a position between the first nip position B1 and the second nip position B2.

### OTHER EMBODIMENTS

The winding device 5 and the recording device 1 according to the present disclosure have the basic configuration of the embodiment described above, but it is of course possible to perform modification, omission, or the like of a partial configuration within a range not departing from the gist of the present disclosure.

In the above description, the case where the angle θ is an acute angle was described, but the present disclosure is not limited thereto. That is, the angle θ may be an obtuse angle.

As a structure for keeping the peeling position A between the first nip position B1 and the second nip position B2, the detection section 23 is provided in the first to third embodiments, and the first detection section 25 and the second detection section 26 are provided in the fourth embodiment. A structure in which the user directly adjusts the rotation speed of the first winding shaft 17 by the speed adjustment section described in the first embodiment may be adopted without providing the detection section 23, the first detection section 25, or the second detection section 26.

What is claimed is:

1. A winding device that transports a medium formed by a fabric attached to a support member having an adhesive surface and that, while transporting the medium in a transport direction, peels the fabric from the support member and then separately winds up the fabric and the support member, the winding device comprising:
a first winding shaft configured to wind the support member;
a second winding shaft configured to wind the fabric peeled off from the support member;
a first nip roller configured to nip the medium at an upstream position in the transport direction of the first winding shaft and of the second winding shaft; and
a second nip roller configured to nip the fabric at a position downstream of the first nip roller in the transport direction, wherein
a peeling position where the fabric is peeled from the support member is a position between a first nip position where the first nip roller nips the medium and a second nip position where the second nip roller nips the fabric.

2. The winding device according to claim 1, wherein
assuming that a direction of the support member from the peeling position toward the first winding shaft is a first direction and a transport direction of the medium toward the peeling position is a second direction, the first winding shaft is disposed at a position where an angle formed by the first direction and the second direction is an acute angle.

3. The winding device according to claim 1, wherein
the first winding shaft is disposed at a position where a component of a winding force by which the support member after the fabric is peeled off is wound around the first winding shaft includes a component in a direction opposite to the transport direction of the medium toward the peeling position.

4. The winding device according to claim 1, further comprising:
a detection section that detects a winding amount of the support member wound around the first winding shaft and
a control section that controls the winding speed of the support member by the first winding shaft based on the winding amount.

5. The winding device according to claim 4, wherein
the detection section includes a driven roller that contacts the support member after the fabric is peeled off and
the control section obtains the winding amount based on rotation of the driven roller.

6. The winding device according to claim 1, further comprising:
a first detection section and a second detection section that are disposed separated from each other at positions sandwiching the support member after the fabric is peeled off and that are configured to detect distance from the support member and
a control section that controls a winding speed of the support member by the first winding shaft based on the distance.

7. The winding device according to claim 1, further comprising:
a drying section configured to dry the medium, wherein
the first nip roller and the second nip roller are disposed both at a position downstream of the drying section in the transport direction and at a position upstream of the drying section in the transport direction and
the first winding shaft is also disposed at both sides corresponding to the first nip roller and the second nip roller that are located downstream and corresponding to a first nip roller and a second nip roller that are located upstream.

8. The winding device according to claim 1, further comprising:
a drying section configured to dry the medium, wherein
the first nip roller and the second nip roller are configured to be movable between a position downstream of the drying section in the transport direction and a position upstream of the drying section in the transport direction and
the first winding shaft is also configured to be movable between a position downstream of the drying section in the transport direction and a position upstream of the drying section in the transport direction.

9. A recording device comprising:
a feed section that feeds a roll-shaped medium in a transport direction, the roll-shaped medium being formed by attaching a fabric to a support member having an adhesive surface;
a recording section that performs recording on the medium; and
a winding device that is located downstream of the recording section in the transport direction and that separately winds the support member and the fabric, wherein
the winding device is according to claim 1.
